(19) United States
(12) Patent Application Publication
(10) Pub. No.: US 2019/0249476 A1
(43) Pub. Date: Aug. 15, 2019

(54) ANTI-PINCH PROTECTION DEVICE FOR A MOTOR VEHICLE SIDE DOOR

(71) Applicant: BROSE FAHRZEUGTEILE GMBH & CO. KOMMANDITGESELLSCHA FT, BAMBERG, Bamberg (DE)

(72) Inventors: Florian POHL, Ebersdorf (DE); Udo GEUTHER, Bamberg (DE); Wolfgang UEBEL, Weitramsdorf (DE); Matthias SCHNAPP, Sonnefeld (DE)

(73) Assignee: BROSE FAHRZEUGTEILE GMBH & CO. KOMMANDITGESELLSCHA FT, BAMBERG, Bamberg (DE)

(21) Appl. No.: 16/315,832

(22) PCT Filed: Jul. 6, 2017
(86) PCT No.: PCT/EP2017/066913

§ 371 Date: Jan. 7, 2019

(30) Foreign Application Priority Data
Jul. 7, 2016 (DE) 10 2016 212 447.1

(51) Int. Cl. E05F 15/46

(52) U.S. Cl. CPC E05F 15/46; E05Y 2900/531; E05Y 2400/32

(57) ABSTRACT

The anti-pinch protection device comprises a proximity sensor for detecting an obstacle, which penetrates the door gap between a hinge-side edge of the side door and a further vehicle component adjacent thereto. The anti-pinch protection device further comprises a control unit interacting with the proximity sensor, which is designed to output a signal indicating an imminent pinching situation whenever the proximity sensor detects an obstacle in the door gap during the closing of the side door. At least one component of the proximity sensor is thereby arranged on the inside of the further vehicle component.

### CROSS-REFERENCE TO RELATED APPLICATIONS

This application is the U.S. National Phase of PCT/EP2017/066913 filed Jul. 6, 2017, which claims priority to DE 10 2016 212 447.1 filed Jul. 7, 2016, the disclosures of which are hereby incorporated in their entirety by reference herein.

### TECHNICAL FIELD

The present disclosure relates to an anti-pinch protection device for a controlled side door of a motor vehicle, which is pivotable around a hinge between a closed position and an open position.

### BACKGROUND

Anti-pinch protection devices are often used in motor vehicles for detecting obstacles in the actuating path of vehicle parts, which are motor-movable with respect to the surrounding parts of the vehicle, by means of example, in vehicle windows, which are lowered by means of an electric window power lifter. If the anti-pinch protection device during a positioning process, i.e. detects an obstacle in the actuating path of the vehicle part during the movement of the vehicle part to be adjusted, it usually generates a signal indicating the impending or already occurred instance of pinching. This signal is usually supplied to the adjusting device moving the vehicle part, which then stops or reverses the adjustment process.

### SUMMARY

Accordingly, an anti-pinch protection device is indicated for a monitored side door of a motor vehicle. The monitored side door is pivotable in the usual manner around a hinge, between a closed position and an open position. Between a hinge-side edge of the side door and an adjacent additional vehicle part, a door gap is constituted, which opens when opening the side door and closes when closing the side door again. The anti-pinch protection device according to one or more embodiments, comprises a proximity sensor for detecting an obstacle intruding into the door gap, and a control unit interacting with the proximity sensor. The control unit is set up to output a signal indicating an imminent pinching event, when the proximity sensor detects an obstacle in the door gap when closing the side door. This signal is hereinafter referred to in brief as a “trigger signal”. The generation and output of this trigger signal for signaling an impending instance of pinching is hereinafter also referred to as “triggering the anti-pinch protection device.”

According to one embodiment, at least one component of the proximity sensor is arranged on the inside of the additional vehicle part. The entire proximity sensor may be arranged on the inside of this additional vehicle part.

Due to the arrangement of at least one component of the proximity sensor (that is, facing the vehicle interior), the above-described door gap can be effectively monitored and in a fail-safe manner. In addition, this arrangement has the advantage that the sensor is particularly well protected against the effects of weather and mechanical damage. In an advantageous embodiment, the said component of the proximity sensor (such as the entire proximity sensor) is at least arranged on the additional vehicle part, such that it is not visible from the outside when the side doors of the motor vehicle are closed. The anti-pinch protection device thereby leaves unimpeded the freedom to design technical design of the vehicle's outer shell.

In a provided application of the anti-pinch protection device according to one or more embodiments, the side door to be monitored is a front side door of the motor vehicle, i.e. around the driver's door or the passenger door. The additional vehicle part adjacent to the joint-side edge of the side door, is constituted in this case by a front fender of the motor vehicle. Thus, in this variant, at least one component of the proximity sensor is arranged on the inside of the front fender.

In a further provided application of the anti-pinch protection device according to one or more embodiments, the side door to be monitored is a rear side door of the motor vehicle. In this case, the additional vehicle part adjoining the hinge-side edge of the side door to be monitored, is a front-side door of the motor vehicle. In this case, at least one component of the proximity sensor is thus arranged on the inside of the front side door (and indeed on the rear edge thereof).

The anti-pinch protection device may be active when closing the side door to be monitored, over the entire duration of this closing operation. However, it may be that the anti-pinch protection device only becomes active if the side door to be monitored is already partially closed, in order to avoid unnecessary signaling of an impending case of pinching when the side door is completely or at least widely open. In the latter case, the control unit is set up to output the triggering signal upon detection of an obstacle, only if the side door to be monitored is in a partial section of its pivoting path adjacent to its closed position.

However, if the side door to be monitored is a rear side door, the activity of the anti-pinch protection device may be dependent on the pivoting position of the front side door. In this case, the control unit is set up to output the triggering signal upon detection of an obstacle, only if the front side door is completely or at least almost closed, when the front side door is thus in a partial section of its pivoting path adjacent to its closed position.

This is based on the awareness that an instance of pinching between the rear side door and the adjacent front side door, cannot occur when the latter is completely or at least widely open. By making the anti-pinch protection device inactive in this case, the likelihood of unnecessary tripping of the anti-pinch protection device is reduced in a simple and effective manner.

In principle, various proximity sensors can be used in the anti-pinch protection device. The proximity sensor can thus be configured, for example, as an infrared, capacitive, ultrasound, radar sensor, or as an optical sensor.

In at least one embodiment, the proximity sensor comprises at least one sensor electrode, which is arranged on the inside of the additional vehicle part (i.e. the fender or the front side door). If the capacitive proximity sensor comprises a number of sensor electrodes, all these sensor electrodes are may be arranged on the additional vehicle part. In principle, however, it is also possible that at least one of the sensor electrodes is arranged on the additional vehicle part, while at least one other sensor electrode of the same proximity sensor is arranged on the side door to be monitored.

The capacitive proximity sensor may operate according to the so-called “one-electrode principle.” In this case, the sensor comprises either only a single transmitting electrode or a number of similar sensor electrodes, wherein an electrical field is established with respect to ground (e.g., a grounded vehicle part) with the/or each sensor electrode. The/each sensor electrode is in this case connected to a capacitive measuring element, which is adapted to measure the capacity/capacitance of the/each sensor electrode to ground.

In another embodiment, the capacitive proximity sensor operates according to the so-called “transmitter-receiver principle”. The capacitive proximity sensor comprises a number of sensor electrodes, of which at least one is operated as a transmitting electrode, and at least one other as a receiving electrode. Such a proximity sensor emits an alternating electric field via the transmitting electrode and measures the capacity/capacitance of the capacitor formed by the two sensor electrodes at the receiving electrode.

The control unit of the anti-pinch protection device may be adapted to compensate for systematic capacity/capacitance changes caused by the movement of the side door to be monitored, in relation to the proximity sensor and other vehicle parts. For this purpose, the control unit compares a capacitance measured variable, detected by the proximity sensor with a predetermined reference value, and outputs the triggering signal only if the capacitance measured variable deviates from the reference value in accordance with a predetermined triggering criterion. The reference value is here variably predetermined as a function of the setting position (pivoting position) of the side door to be monitored, for example in the form of a mathematical function or in the form of a statistical value table.

If the side door to be monitored is a rear side door, the reference value may depend on the setting position (pivoting position) of the adjacent front side door. The reference value in this case therefore depends on both the positioning position of the rear side door and the positioning position of the front side door.

The dependence of the reference value on the setting position of the monitored side door—as well as also the dependence on the setting position of the front side door, if the rear side door is monitored—may be trained during operation of the anti-pinch protection device and adapted automatically to changing environmental conditions.

The side door to be monitored may be assigned an adjusting device with an (in particular electric) servomotor, by means of which the side door is automatically adjustable between the closed position and the open position. In this case, the triggering signal output by the anti-pinch protection device is supplied to the adjusting device, which in turn is adapted to stop or reverse a closing movement of the side door upon receipt of the triggering signal. In principle, the anti-pinch protection device can also be implemented in manually operated side doors. In this case, a warning, for example, a warning tone, may expediently triggered by the triggering signal. However, such a warning can be provided as (in particular additional) reaction to the generation of the triggering signal also in motorized side doors.

The motor vehicle according to one or more embodiments may include at least one (in particular motor-driven) side door, which is pivotable around a hinge between a closed position and an open position. The motor vehicle further comprises the anti-pinch protection device. With the above-described embodiments and further developments of this anti-pinch protection device, corresponding embodiments and further developments of the motor vehicle, so that in this respect reference is made to the above statements.

### BRIEF DESCRIPTION OF THE DRAWINGS

Embodiments will be explained in more detail with reference to a drawing. In which are shown:

FIG. 1 in a rough schematic side view of a motor vehicle with a front side door and a rear side door,

FIG. 2 in a schematically simplified horizontal partial section, a side panel of the motor vehicle according to FIG. 1 with the two side doors as well as a front fender and a rear fender,

FIG. 3 in a further schematic side view of the motor vehicle, each with an actuator for motorized movement of the front side door and the rear side door, and with one (front and rear) anti-pinch protection device for the hinged door gap of the front side door and the rear side door,

FIG. 4 in a detailed view IV of FIG. 2, the hinge-side edge of the front side door and a capacitive proximity sensor of the front anti-pinch protection device, which is mounted on the inside of the front fender,

FIG. 5 in a detailed view V of FIG. 2, the hinge-side edge of the rear side door, and a mounted on the inside of the front side door capacitive proximity sensor of the rear anti-pinch protection device, as well as a capacitive proximity sensor of the rear anti-pinch protection device mounted inside the front side door, and

FIG. 6 in a diagram against the setting position of the rear side door, as well as the setting position of the front side door, the course of a reference value, which compares the rear anti-pinch protection device with a capacitive measurement of the associated capacitive proximity sensor, in order to distinguish an imminent instance of pinching from a normal, door-position-dependent capacity/capacitance change.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Corresponding parts and sizes are always provided with the same reference numerals in all figures.

A distinction is made between direct and indirect anti-pinch protection devices. An indirect (force-based) anti-pinch protection device usually detects the instance of pinching by monitoring the speed or the motor current of the servomotor of the actuator. In this case, utilization is made of the fact that, in the event of a case of pinching that has already occurred, the obstacle opposes the further movement of the vehicle part to be adjusted, with a force which leads to an abnormal increase in the motor current or an abnormal decrease in the engine speed.

In contrast, a direct anti-pinch protection device typically includes one or more sensors, which detect a characteristic variable for the absence or presence of an obstacle, as well as a control unit that decides on the basis of this measurement, whether there is an obstacle in the actuating path and optionally triggers the signal described above.

Among the direct anti-pinch protection devices, one differentiates between systems with so-called touch sensors, which indicate the presence of an obstacle, when the obstacle already touches the sensor, and systems with non-contact sensors, that detect an obstacle already at a certain distance to the sensor. The non-contact sensors include in particular so-called capacitive proximity sensors.

As automation progresses in automotive engineering, mobile vehicle parts which have traditionally been manually operated, are increasingly equipped with motorized actuators. In particular, concepts for the motorized operation of the pivotable side doors of a motor vehicle have been developed in recent years. The problem here is in particular the door gap, which opens when such a side door is opened between the hinge side edge of the side door and an adjacent additional vehicle part, especially since here the vehicle door exerts particularly high forces when closing due to the short lever travel (i.e., the short distance between the hinge side edge of the side door and the hinge axis) on any possible obstacles. This can be known to result in the catching of body parts, such as for example a hand in the door gap.

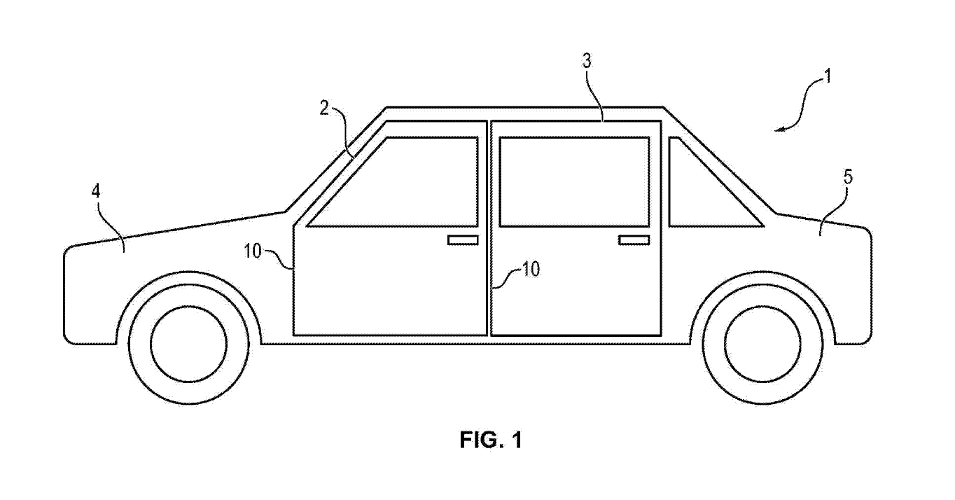

FIG. 1 shows in a rough schematic simplification of a motor vehicle 1, that in a conventional manner comprises two side doors on both sides in each case, namely in each case a front side door 2 and a rear side door 3. Approximately in the middle of the vehicle, namely in the area of the so-called B-pillar (not explicitly shown), the two side doors 2 and 3 abut each other directly. On the front side of the motor vehicle 1, the front side door 2 is connected by a front fender 4. Towards the rear of the vehicle, the rear side door 3 is connected to a rear fender 5.

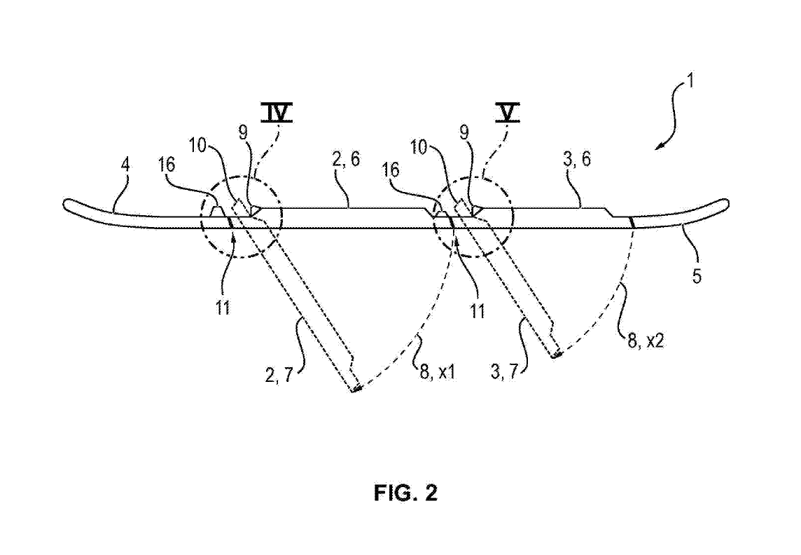

The side panel of the motor vehicle 1 formed from the front fender 4, the front side door 2, the rear side door 3 and the rear fender 5 is shown in FIG. 2 in a roughly schematically simplified horizontal partial section. From this representation it can be seen that each of the two side doors 2 and 3 is pivotally reversibly swiveling between a closed position 6 and an open position 7 on the vehicle chassis. In the respective closed position 6, the side doors 2 and 3 are each shown here by solid lines. The side doors 2 and 3, however, in each case in the open position 7 are shown with dashed lines.

The respective space area, which the side doors 2 and 3 covers during the pivoting movement between the closed position 6 and the respective opening position 7, is referred to as pivot path 8. The respective current pivot position along this pivot path 8, is referred to in the case of the front side door 2 as a setting position x1 and in the case of the rear side door 3 as a setting position x2. The setting positions x1 and x2 are to be understood here as mathematical variables which, for example, have the value zero (x1, x2=0) in the closed position 6, and a positive value (x1, x2>0) which is different from zero in the respective opening position 7.

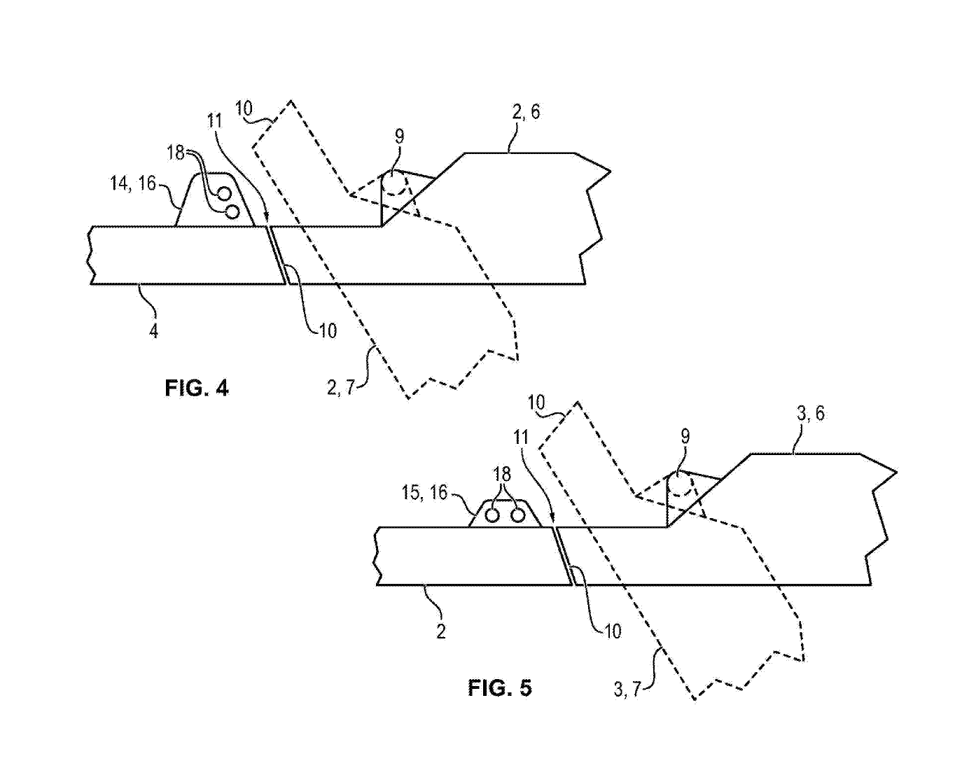

As usual, in the motor vehicle 1, both side doors 2 and 3 each pivot around a hinge 9, which is arranged close to the vehicle front side facing edge of the respective side door 2,3. This front edge of the side doors 2 and 3 is therefore also referred to as hinged side edge 10 of the respective side door 2,3. As shown in FIG. 2, but more clearly apparent from FIGS. 4 and 5, this hinge side edge 10 emerges slightly when opening the respective side door 2,3 in the vehicle interior, while the respective rear edge of the side door 2,3 pivots outwardly. By this emerging of the hinge-side edge 10, a door gap 11 results when opening the front side door 2 between the hinge-side edge 10 and the front fender 4. A similar door gap 11 is formed when opening the rear side door 3 between the hinge-side edge 10 of this side door 3, and the rear edge of the front side door 2, if the front side door 2 is closed.

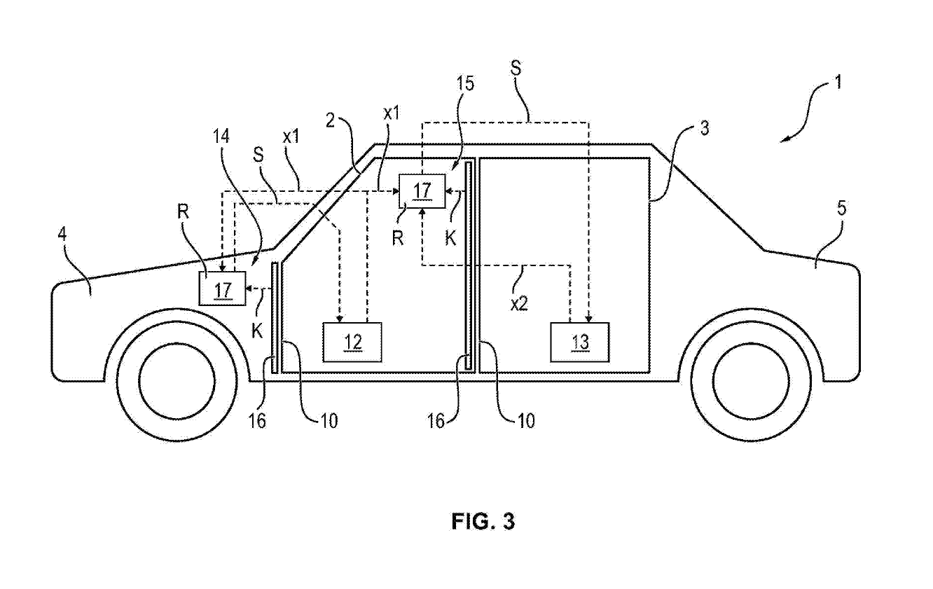

As is roughly indicated schematically in FIG. 3, each of the side doors 2 and 3 is assigned an adjusting device 12 or 13, which automatically pivots the respective side door 2, 3 along the pivoting path 8. Each adjusting device 12,13 comprises, in a manner not shown, an electric servomotor which acts on the associated side door 2,3 via an adjusting mechanism. Each adjusting device 12,13 further comprises a control unit designated as engine control unit (likewise not explicitly shown) for controlling the servomotor. The engine control units are constituted, for example, by microcontrollers in which operating software (firmware) is implemented.

In order to prevent an obstacle (e.g., a body part of a vehicle user such as a finger or an object) from being pinched in the respective associated door gap 11 when automatically closing one of the side doors 2,3, each of the two side doors 2 and 3 is assigned respectively an anti-pinch protection device 14 and 15. Each of the two anti-pinch protection devices 14, 15 thus in each case comprises a capacitive proximity sensor 16 and an associated control unit 17. The anti-pinch protection device 14 associated with the front side door 2 is also referred to as the front anti-pinch protection device 14. The anti-pinch protection device 15 assigned to the rear side door 3 is accordingly also referred to as the rear anti-pinch protection device 15.

As can be seen from FIG. 3, the proximity sensor 16 of the front anti-pinch protection device 14 has an elongated shape. It is in this case mounted on the inside of the front fender 4, so that it flanks the hinge-side edge 10 of the side door 2 and/or the door gap 11 to be monitored, with a small distance over its entire length. Similarly, the capacitive proximity sensor 16 of the rear anti-pinch protection device 15 has an elongated shape. This proximity sensor 16 is mounted on the inside of the front side door 2, so that it flanks the hinge-side edge 10 of the side door 2 and/or the door gap 11 to be monitored, with a small distance over its entire length.

For the front side door 2 and the front anti-pinch protection device 14, the arrangement of the proximity sensor 16 in FIG. 4 is shown in greater detail. From this it can be seen that the proximity sensor 16 has two sensor electrodes 18 designed as round cables, which are arranged here substantially next to one another in the transverse direction of the vehicle.

For the rear side door 3 and the rear anti-pinch protection device 15, the arrangement of the proximity sensor 16 in FIG. 5 is shown enlarged. It can be seen from this illustration that in this case also, the proximity sensor 16 comprises two sensor electrodes 18. However, these sensor electrodes 18 are arranged side by side in the longitudinal direction of the vehicle.

The arrangement of the sensor electrodes 18 follows primarily technical conditions for installation space and is therefore dissimilar for different vehicle types if necessary. In particular, the electrode arrangement according to FIG. 5 can also be used with the front anti-pinch protection device 14, if this is necessary for reasons of the available installation space. Conversely, the electrode arrangement according to FIG. 4 can also be used for the rear anti-pinch protection device 15.

In addition to these sensor electrodes 18, the proximity sensor 16 in both cases respectively comprises a signal generating circuit, not shown in detail, as well as a capacitive measuring element, also not shown in detail.

The two capacitive proximity sensors 16 of the anti-pinch protection devices 14 and 15 may operate according to the above-mentioned “transmitter-receiver principle.” Accordingly, one of the two sensor electrodes 18 is operated during operation of the respective proximity sensor 16 as a transmitting electrode, in that the signal generating circuit of the proximity sensor 16 applies an alternating electrical voltage to this sensor electrode.

During action of this alternating electrical voltage, said sensor electrode 18 generates an electric field which propagates in the surrounding space, and thus in particular in the door gap 11. The respective other sensor electrode 18 of the respective proximity sensor 16 is operated as a receiving electrode, in that, by means of the capacitance measuring element, the displacement current induced in this sensor electrode 18 under the action of the electric field is measured. From the measured displacement current, the capacitive measuring element derives a (capacitance) measured variable K, which is characteristic of the (electrical) capacitance of the capacitor formed by the sensor electrodes 18. The proximity sensor 16 supplies this capacitance variable K to the associated control unit 17 as an input variable.

The control unit 17 compares the supplied capacity/capacitance measurand K with a predetermined reference value R which determines the expected (normal) value of the capacity/capacitance measured K and in the undisturbed case, i.e. in the absence of an obstacle reflected in the door gap 11.

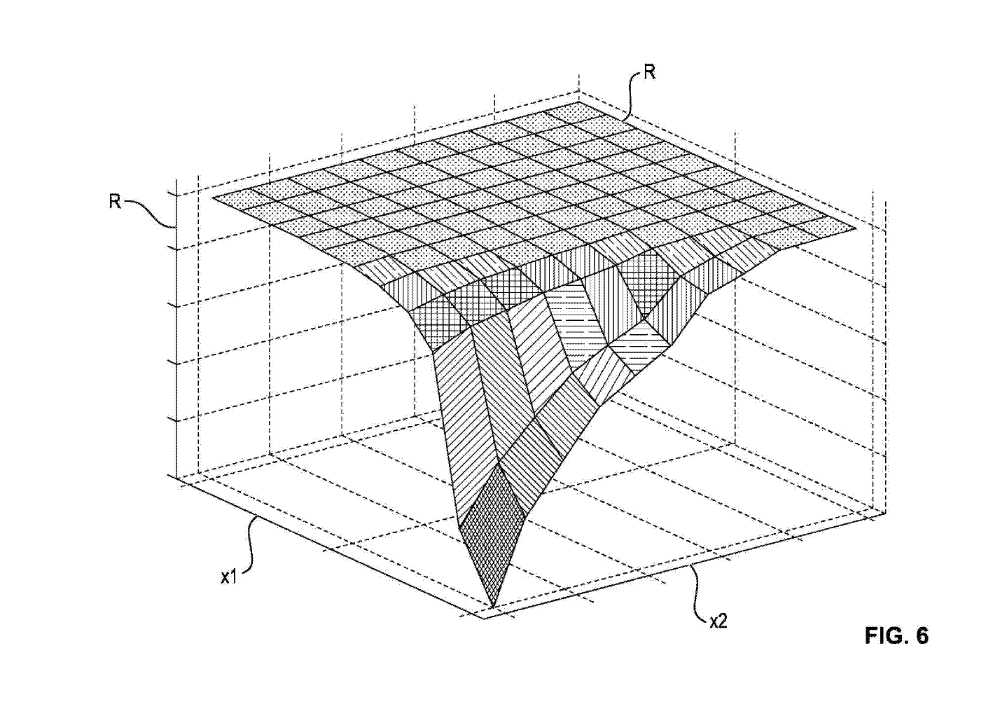

In the case of the front anti-pinch protection device 14, this normal value of the capacity/capacitance variable K depends on the setting position x1 of the associated side door 2. Therefore, here the reference value R is provided in the form of a characteristic table variable as a function of the setting position x1. In the anti-pinch protection device 15, the normal value of the capacity/capacitance variable K is dependent not only on the setting position x2 of the associated side door 3, but also from the setting position x1 of the front side door 2, especially since the proximity sensor 16 is arranged on the front side door 2 and is moved with this. In this case, the reference value R is therefore provided as a three-dimensional characteristic field, both as a function of the setting position x1 and as a function of the setting position x2. This dependence of the reference value R on the setting positions x1 and x2 is shown by way of example in FIG. 6.

In order to be able to determine the dependent reference value R of the door position, the control unit 17 of the anti-pinch protection device 14 is supplied with the current value of the setting position x1 by the actuator 12. Correspondingly, the control unit 17 of the anti-pinch protection device 15 receives from the adjusting devices 12 and 13 the respectively current value of the setting positions x1 and x2.

Each of the two control units 17 continuously compares the capacity/capacitance measurement variable K supplied by the associated proximity sensor 16 with the reference value R. As a triggering criterion for the signaling of an imminent instancing of pinching, a tolerance threshold is stored in the respective control unit 17. If the comparison of the capacity/capacitance measurement variable K with the reference value R shows that the capacity/capacitance variable K deviates from the reference value R by more than the tolerance threshold, the control unit 17 recognizes this deviation as an indication of the presence of an obstacle in the respectively associated door gap 11.

In this case, the respective control unit 17 generates a trigger signal S and sends this trigger signal S to the associated actuating device 12 and/or 13. The adjusting devices 12 and 13 are in this case configured to immediately end the current closing operation of the respective side door 2 and/or 3 upon receipt of the triggering signal S, and to slightly reverse the door movement.

Both anti-pinch protection devices 14 and 15 are basically active when closing the respectively monitored side door 2 and/or 3 over the entire duration of this closing operation (thus independent of the setting position x1 and/or x2). However, the activation of the rear anti-pinch protection device 15 is made dependent on the position x1 of the front side door 2. Thus, the anti-pinch protection device 15 is activated only when the front side door 2 is completely or at least almost closed. If however the setting position x1 lies outside a partial section of the pivot path 8 adjoining the closed position 6 (x1=0), on the other hand, the anti-pinch protection device 15 becomes inactive, so this takes into account the fact that when the front side door 2 is open, no obstacles can be pinched between it and the rear side door 3.

In another embodiment, which is not explicitly shown, the anti-pinch protection device 15 is additionally used to monitor the rear (lock-side) door gap of the front side door 2. Here, the anti-pinch protection device 15 is also active when closing the front side door 2, in which the capacity/capacitance measurement variable K determined by the associated proximity sensor 16, is again compared with the predetermined reference value R. If this comparison shows that the capacity/capacitance measurement variable K deviates from the reference value R by more than a predetermined tolerance threshold, the control unit 17 of the anti-pinch protection device 15 generates a further triggering signal in this case. This further triggering signal is supplied to the front adjusting device 12, which then stops or reverses the closing movement of the front side door 2.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### LIST OF REFERENCE TERMS

1 Motor vehicle
2 (front) side door
3 (rear) side door
4 (front) fender
5 (rear) fender
6 Closed position
7 Open position
8 Pivot path
9 Hinge
10 (hinge side) edge
11 Door gap
12 Actuator
13 Actuator
14 Anti-pinch protection device
15 Anti-pinch protection device
16 Proximity sensor
17 Control unit
18 Sensor electrode
x1 Setting position
x2 Setting position
K (Capacity/Capacitance -) variable
R Reference value
S Triggering signal

1-10. (canceled)

11. An anti-pinch protection device for a motor vehicle that includes a front side door and a rear side door each pivotable a hinge between a closed position and an open position, the anti-pinch protection device comprising:
a capacity/capacitance proximity sensor configured to provide a capacity/capacitance variable indicative of a capacitance of an electric field in a door gap between a hinge-side edge of the front or rear side door and an adjoining additional vehicle part
a control unit configured to, responsive to the capacity/capacitance variable of the door gap deviating from a predetermined reference value based on a setting position of the front or rear side door, send a triggering signal.

12. The anti-pinch protection device of claim 11, wherein at least one component of the capacity/capacitance proximity sensor is arranged on the additional vehicle part such that it is not visible when the front side door and a rear side door are closed.

13. The anti-pinch protection device of claim 11, wherein the adjoining additional vehicle part is a fender.

14. The anti-pinch protection device of claim 11, wherein the control unit is further configured to send the triggering signal in response to the front side door being in a partially closed position.

15. The anti-pinch protection device of claim 11, wherein the capacity/capacitance proximity sensor includes a first sensor electrode that is arranged on an inner portion of the adjoining additional vehicle part.

16. The anti-pinch protection device of claim 15, wherein the capacity/capacitance proximity sensor includes a second sensor electrode, and wherein the first sensor electrode and the second sensor electrode are arranged substantially next to one another so that they are transverse to a longitudinal direction of the vehicle.

17. An anti-pinch protection device for use in a vehicle that includes a fender, a first door, and a second door each configured to move between a closed position and an open position, the anti-pinch protection device comprising:
a first actuator configured to move the first door in a first direction and a second direction;
a capacitive proximity sensor configured to generate an electric field in a door gap defined by the first door and the fender and measure a capacitance of the electric field; and
a control unit configured to, responsive to the capacitance deviating from a predetermined reference value, based on a position of the first door, actuate the first actuator to reverse the movement of the first door.

18. The anti-pinch protection device of claim 17, wherein the controller is further configured to receive the position of the first door from the first actuator.

19. The anti-pinch protection device of claim 17, wherein the capacitive proximity sensor includes a transmitting electrode and a receiving sensor electrode, wherein the transmitting electrode generates the electric field and the receiving sensor electrode measures the capacitance of the electric field.

20. The anti-pinch protection device of claim 19, wherein the capacitive proximity sensor includes a signal generating circuit configured to apply an alternating electrical voltage to the transmitting electrode.

21. The anti-pinch protection device of claim 17, wherein the controller is further configured to, responsive to the first actuator moving the first door, stop moving the first door.

22. An anti-pinch protection device for use in a vehicle that includes a fender, a first door, and a second door each configured to move between a closed position and an open position, the anti-pinch protection device comprising:
a first actuator configured to move the first door in a first direction and a second direction;
a first capacitive proximity sensor configured to generate an electric field in a first door gap defined by the first side door and the fender and measure a capacitance of the electric field;
a second actuator configured to move the second door in the first direction and the second direction;
a second capacitive proximity sensor configured to generate a second electric field in a second door gap defined by the first door and the second door and measure a second capacitance of the electric field; and
a control unit configured to, responsive to the first capacitance deviating from a first predetermined reference value, based on a position of the first door, or the second capacitance deviating from the second predetermined reference value, based on the position of the first door and the position of the second door, actuate the first actuator to reverse the movement of the first door, or actuate the second actuator to reverse the movement of the second door, or both.

23. The anti-pinch protection device of claim 22, wherein the controller is further configured to, responsive to the first door being in either a partially closed or closed position and the second actuator moving the second door, actuate the second actuator to reverse the movement of the second door.

24. The anti-pinch protection device of claim 22, wherein the first capacitive proximity sensor is disposed on an inner portion of the fender.

25. The anti-pinch protection device of claim 22, wherein the second capacitive proximity sensor is disposed on an inner portion of the first door.

26. The anti-pinch protection device of claim 22, wherein the controller is further configured to receive the position of the first door from the first actuator.

27. The anti-pinch protection device of claim 26, wherein first predetermined reference value is obtained from a lookup table.

28. The anti-pinch protection device of claim 27, wherein the controller is further configured to, responsive to the first predetermined reference value exceeding a tolerance threshold.

29. The anti-pinch protection device of claim 22, wherein the controller is further configured to, responsive to the first door moving towards the closed position and the second capacitance deviating from the second predetermined reference value, cease actuation of the first actuator to stop moving the door to the closed position.

30. The anti-pinch protection device of claim 22, wherein the controller is further configured to receive the position of the second door from the second actuator.
